(19) United States
(12) Patent Application Publication
(10) Pub. No.: US 2020/0315760 A1
(43) Pub. Date: Oct. 8, 2020

(54) PERIODONTAL POCKET DEPTH MEASURING DEVICE

(71) Applicant: Shu-Chen TSAI, Taipei City (TW)

(72) Inventor: Yoshiaki AKIHIRO, Taipei City (TW)

(21) Appl. No.: 16/447,263

(22) Filed: Jun. 20, 2019

(30) Foreign Application Priority Data
Apr. 8, 2019 (TW) 108112191

(51) Int. Cl. A61C 19/04

(52) U.S. Cl. CPC A61C 19/043

(57) ABSTRACT

A periodontal pocket depth measuring device comprising:
a main body;
a probe tabular in shape extending from a side of the main body and the probe is mounted within the main body, the probe comprises a concave structure which is located at the front end of the protruding direction and in the middle of the tabular width direction;
a lip extending from the side of the main body along the same protruding direction as the probe, wherein the lip can freely move in parallel to the protruding direction, the lip is slidably mounted into the main body and is located close to the probe; and
a measuring portion measuring the depth by measuring the movement in a direction opposite to the lip protruding direction.

### CROSS-REFERENCE TO RELATED APPLICATIONS

This application claims priority to Taiwanese application No. 108112191 having a filing date of Apr. 8, 2019, the entire content are hereby incorporated by reference.

### FIELD OF TECHNOLOGY

This invention provides a periodontal pocket depth measuring device.

### BACKGROUND

Recent studies have shown that periodontitis is an infectious disease which is found to be closely associated with diabetes or cerebrovascular disease and other habitual diseases. Periodontitis does not have symptoms before developing into advanced periodontitis. Therefore, it is often too late when there are symptoms such as gingivitis, bad breath, tooth mobility, etc.

Typically, a periodontal pocket depth measuring device is used to measure the periodontal pocket depth to diagnose periodontitis. The front end of the measuring portion of the periodontal pocket depth measuring device is inserted into the periodontal pocket to measure the periodontal pocket depth. The teaching is disclosed in Japan patent number 2012-005761.

In traditional periodontal pocket depth measuring devices, the probe contacts the upper rim of the calculus on root surfaces and cannot be inserted deeper than the upper rim of the calculus. Therefore, the upper rim of the calculus is often mistaken as the bottom of the periodontal pocket, which causes inaccuracy of the measurement of a periodontal pocket.

### SUMMARY

This invention aims to provide a periodontal pocket depth measuring device, which can accurately measure the periodontal pocket depth regardless of the calculus on the root.

A periodontal pocket depth measuring device comprising: a main body; a probe tabular in shape extending from a side of the main body and the probe is mounted within the main body, the probe comprises a concave structure which is located at the front end of the protruding direction and in the middle of the tabular width direction; a lip extending from the side of the main body along the same protruding direction as the probe, wherein the lip can freely move parallel to the protruding direction, the lip is slidably mounted into the main body and is located close to the probe; and a measuring portion measuring the depth by measuring the movement in a direction opposite to the lip protruding direction.

When the probe and the lip are inserted into the oral cavity, the front end of the protruding direction of the probe is inserted into a periodontal pocket to measure the pocket depth. While the lip contacts the gum and moves in the opposite direction of the protruding direction, the calculus attached on the tooth root enters the concave structure of the probe and the probe is able to cross over the calculus and to be inserted deeper into the periodontal pocket.

According to this invention, although there is calculus attached to the tooth root, the periodontal pocket depth can still be accurately measured.

### BRIEF DESCRIPTION

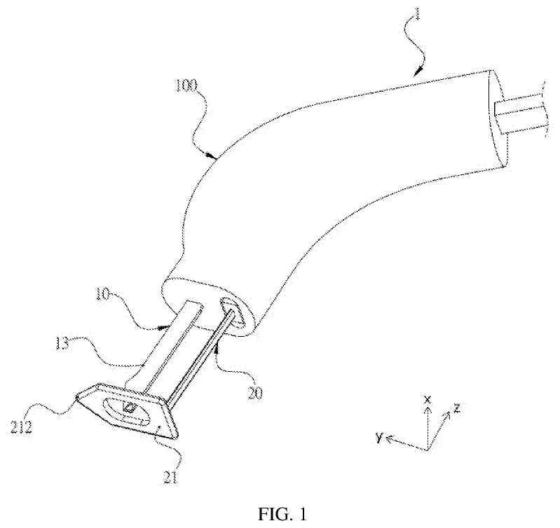

FIG. 1 is an oblique view of the periodontal pocket depth measuring device in accordance with the embodiment of the present invention;

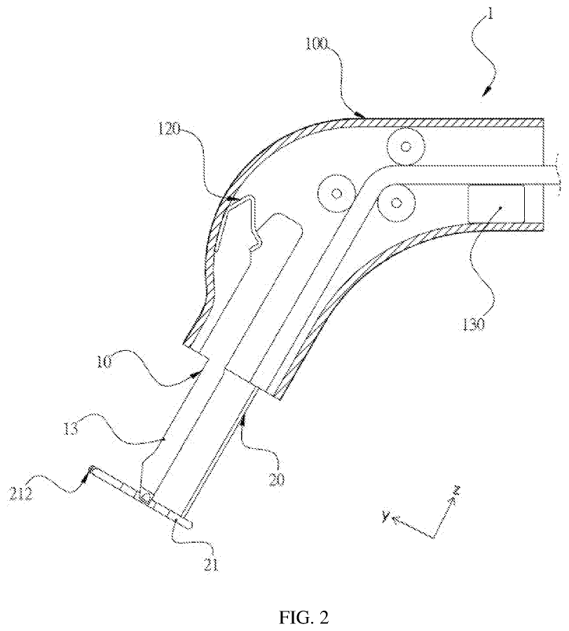

FIG. 2 is a side view of the periodontal pocket depth measuring device in accordance with the embodiment of the present invention;

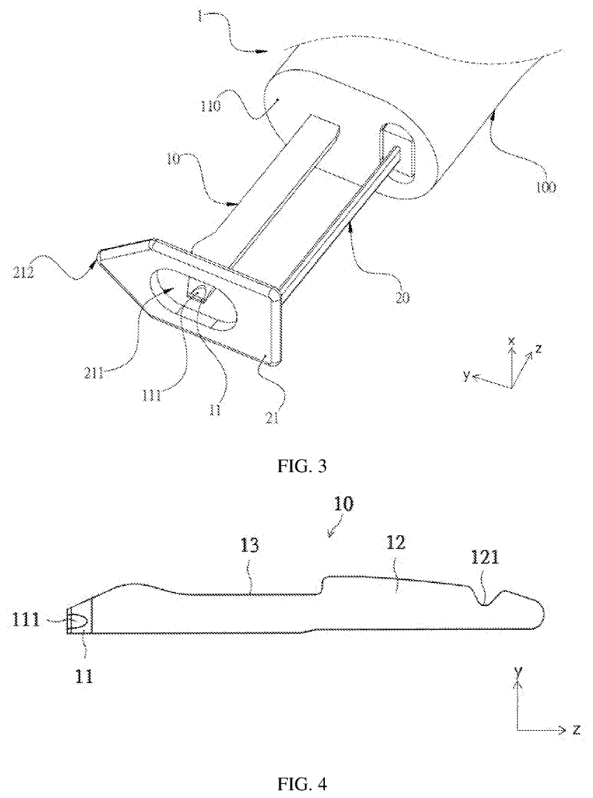

FIG. 3 is a partially enlarged oblique view of the periodontal pocket depth measuring device in accordance with the embodiment of the present invention;

FIG. 4 is a side view of the probe of the periodontal pocket depth measuring device in accordance with the embodiment of the present invention;

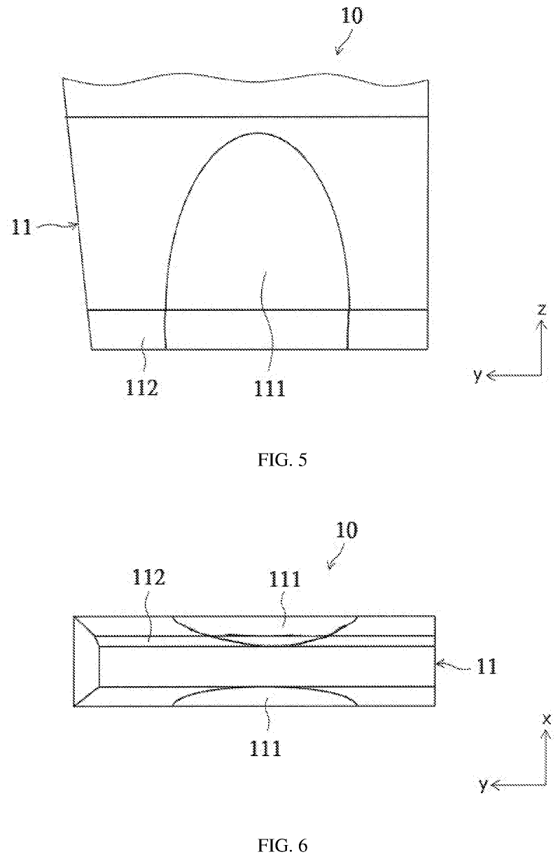

FIG. 5 is a side view of the inserting portion of the probe of the periodontal pocket depth measuring device in accordance with the embodiment of the present invention;

FIG. 6 is a bottom view of the inserting portion of the probe of the periodontal pocket depth measuring device in accordance with the embodiment of the present invention;

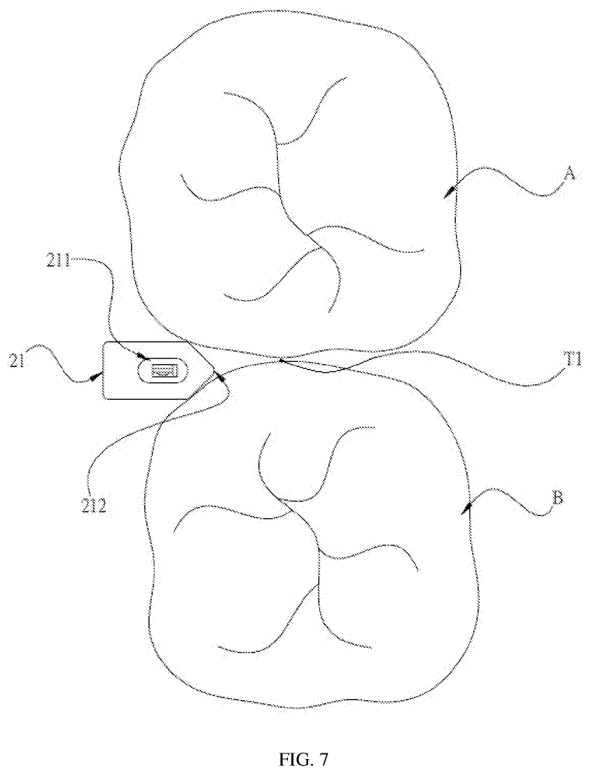

FIG. 7 is a representative figure of the condition that the probe of the periodontal pocket depth measuring device is being inserted in the periodontal pocket in accordance with the embodiment of the present invention; and

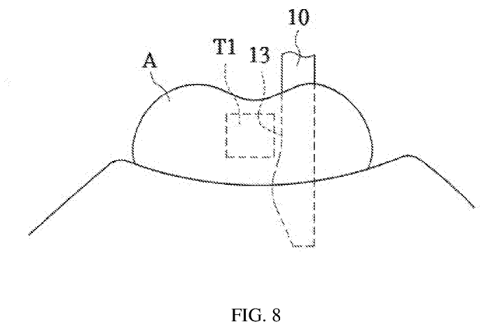

FIG. 8 is a representative figure of the condition that the probe and the lip of the periodontal pocket depth measuring device are being inserted in the periodontal pocket in accordance with the embodiment of the present invention.

### DETAILED DESCRIPTION

Referring to FIGS. 1 to 6, the periodontal pocket depth measuring device 1 in the embodiment of the present invention is described below. Figures are illustrated with description using orthogonal coordinate system of X axis, Y axis and Z axis. The positive direction of Y axis is forward, while the negative direction of Y axis is backward; the positive direction of X axis is right, while the negative direction of X axis is left; and the positive direction of Z axis is upward and negative direction of Z axis is downward. Moreover, the descriptions of figures are used to explain the present invention, the items in the drawings may not be the actual proportion.

### [The Composition of the Periodontal Pocket Depth Measuring Device]

The periodontal pocket depth measuring device 1 comprises a main body 100, a probe 10 and a lip 20.

The main body 100 is formed by binding a housing shell and a lid closely. It forms into an L shape from the side view. FIG. 2 shows the main body 100 without the housing shell.

The inside of the main body 100 comprises a measuring portion 130 that measures the amount of movement relative to the position of the lip 20, and a spring part 120 provides an elastic force for the probe 10 to spring forward.

A measuring portion 130 can be a light sensor that is used to measure the amount of movement relative to the position of the lip 20 and is placed at the slit of the lip 20, unseen from the figures. The measuring portion 130 can also be an electrical resistance detector that measures the amount of movement relative to the position of the lip 20 by a change in electrical resistance value when the lip is inserted into the periodontal pocket. The measuring result of the amount of movement relative to the position of the lip 20 is transmitted wirelessly by a communication portion, unseen from the figures, to an external personal computer. It can also be stored in memory devices of the main body 100 such as a removable USB memory stick.

The probe 10 is tabular in shape and made of paper. The probe 10 is fixed and cannot be moved in upward and downward direction relative to the main body 100. The probe 10 also protrudes from the protruding end surface 110 of an end of the main body 100. More specifically, the probe 10 comprises an inserting portion 11, a holding portion 12 and a concave area 13.

The holding portion 12 is mounted within the main body 100. It also comprises a fit concave portion 121 where the spring part 120 of the main body 100 fits in the fit concave portion 121.

The inserting portion 11 is placed at the front end of the probe 10 in the protruding direction. The inserting portion 11 comprises a concave structure 111 which is located in the middle of the tabular width direction (forward-backward direction) and concaves into a semicircular shape from the front end of the protruding directing towards the main body 100. As shown in FIG. 6, the thickness gets narrower towards the front end of the protruding direction and the inclined planes 112 of both left and right tilted sides form into a blade shape. The front end of the protruding direction extends upward to a certain length and is inserted into the periodontal pocket. Moreover, the inserting portion 11 is at the front end of the protruding direction with a predetermined angle with respect to the tabular width direction and extends along the tabular width direction.

The concave area 13 is in between the inserting portion 11 and the holding portion 12 and concaves from the front end of the side of the tabular width direction toward the back of the inner side.

The lip 20 is sprung out from below of the protruding direction by a spring part unseen from the figures. Meanwhile, the downward movement of the lip 20 is restricted by the protruding end surface 110, and the lip 20 is made of paper. The lip 20 protrudes from the protruding end surface 110 of the main body 100 in the same direction as the probe 10 protrudes from the protruding direction, and moves freely in parallel to the protruding direction and the lip is slidably mounted into the main body 100, and locates around the probe 10 without touching the probe 10. The lip 20 comprises a tabular portion 21 that intersects with the protruding direction of the lip and at around the front end of the inserting portion 11.

The tabular portion 21 comprises an insertion through-hole 211 which allows the probe 10 to insert through. The tabular portion 21 comprises a protruding portion 212 that protrudes outwardly from an end (front end) of the tabular width direction towards the front (tabular width direction). The front end surface of the protruding direction of the tabular portion 21 is approximately at the same position in the upward and downward direction as the front end surface of the protruding direction of the inserting portion 11.

### [Operation of Periodontal Pocket Depth Measuring Device]

Referring to FIGS. 1 to 8, the operation of the periodontal pocket depth measuring device 1 in this invention is described in details below. Moreover, in FIG. 8, the tooth B is at the inner side of the paper side of the tooth A.

The power switch, unseen from the figures, of the periodontal pocket depth measuring device 1 is turned on to use the device.

Firstly, insert the inserting portion 11 of the probe 10 and the tabular portion 21 of the lip 20 in the side of the periodontal pocket to measure the periodontal pocket depth.

Additionally, when the bottom of the tabular portion 21 touches the gum, the lip 20 starts to shrink back upwards into the main body 100 in a direction opposite of the protruding direction and the inserting portion 11 inserts into the periodontal pocket simultaneously. Meanwhile, the lip 20 does not have a fulcrum and moves in the opposite direction of the protruding direction of the probe 10 independently. On the other hand, the probe 10 can rotate on the y-z plane using an elastic force of the spring part 120 with a fulcrum of the main body 100 unseen from the figures.

Moreover, referring to the protruding portion 212 of the tabular portion 21 in FIG. 7, the protruding portion 212 is placed in between the connected tooth A and tooth B. The probe 10 can be placed as closely as possible at contacting area T1 where the tooth A and the tooth B touches. Therefore, the periodontal pocket depth right beneath the contacting area T1 of the adjacent tooth A and tooth B can be more accurately measured.

Moreover, referring to the concave area 13 of the probe 10 in FIG. 8, the concave area 13 can avoid the contacting area T1 of the adjacent tooth A and tooth B; therefore the probe 10 can be placed in a state more vertical to the periodontal pocket and is suitable to measure the periodontal pocket depth. Hence, the probe 10 can more accurately measure the periodontal pocket depth right beneath the contacting area T1 of the adjacent tooth A and tooth B.

Moreover, when there is calculus on the tooth root, the front end of the protruding direction of the inserting portion 11 temporarily stops when it contacts with the upper rim of the calculus. However, the concave structure 111 of the inserting portion 11 enables the calculus to fall into the concave structure 111, and the inserting portion 11 can easily cross over the calculus. Therefore, although there is calculus on the tooth root, the device is still able to accurately measure the periodontal pocket depth. More specifically, the concave structure 111 is semicircular in shape, can successfully induce the calculus into the concave structure 111 and enables the inserting portion 11 to easily cross over the calculus.

Moreover, the inclined plane 112 located at the front end of the protruding direction of the inserting portion 11 enables the inserting portion 11 to move left and right when the inserting portion 11 contacts the upper rim of the calculus. The inclined plane 112 is further pushed deeper into the calculus, and thus inducing the calculus into the concave structure 111. The inserting portion 11 can easily cross over the calculus and can prevent the front end of the protruding direction of the inserting portion 11 from hurting the gum or the mucosa of the inner oral cavity.

Moreover, the front end of the protruding direction comprises a predetermined angle with respect to the tabular width direction and extends along the tabular width direction. A user of the periodontal pocket depth measuring device 1 can move the inserting portion 11 back and forward, and the probe 10 can successfully be inserted in the deep end of the periodontal pocket and not stuck at the gum or the calculus. The inserting portion 11 can prevent the front end of the protruding direction from hurting the gum or the mucosa of the inner oral cavity.

Since the front end of the protruding direction of the inserting portion 11 contacts the inner bottom of the periodontal pocket, the probe 10 cannot be further inserted into the periodontal pocket. The measuring portion 130 can measure the amount of movement relative to the position of the lip 20 and transmit the measuring results wirelessly to an external personal computer unseen from the figures. It can also be stored in a memory device of the main body 100, unseen from the figures, such as a portable USB memory stick of the main body 100 to analyze the periodontal pocket depth.

After measuring the periodontal pocket depth, the inserting portion 11 is taken out of the periodontal pocket, and the lip 20 is sprung back to the initial position in FIGS. 1 and 2 by the elastic force of the spring part unseen from the figures.

Lastly, the power switch of the periodontal pocket measuring device 1 is switched off to finish the measuring of the periodontal pocket depth.

Additionally, a front end of the protruding direction of a traditional probe is in pointed shape. When the front end of the protruding direction of the traditional probe is stuck in the calculus on the tooth root, the probe cannot be further inserted into the deeper end of the periodontal pocket. On the contrary, the inserting portion 11 of the probe 10 in this embodiment is in tabular shape, it can prevent the inserting portion 11 from being stuck in the calculus and can be further inserted into the deeper end.

Therefore, according to this embodiment, the probe 10 comprises a concave structure 111 which is located at the front end of the protruding direction and in the middle of the tabular width direction. Hence, the periodontal pocket depth can still be accurately measured even if there is calculus on the tooth root.

Moreover, according to this embodiment, the probe 10 and the lip 20 are made of paper. They are disposable and hygienic.

The types, configuration and quantity of the components in this invention are not limited to the aforementioned embodiments. Proper modifications to change the components and achieve the same results are possible within the scope of the invention.

More specifically, in the aforementioned embodiments, although the concave structure 111 is semicircular in shape, it is not limited and can be in other shapes such as triangles.

Moreover, in the aforementioned embodiments, although the inserting portion 11 is rectangular in shape, it is not limited and can be in curved shape, with the middle of forward and backward direction that protrudes outward in left and right direction and curves in forward and backward direction from the bottom view. Therefore, the front end of the protruding direction of the inserting portion 11 can prevent injury of the gum or mucosa of the inner oral cavity.

Moreover, in the aforementioned embodiments, although the probe 10 and the lip 20 are made of paper, it is not limited and can be made of other materials other than paper such as plastic, etc.

Moreover, in the aforementioned embodiments, although the inclined plane 112 is at one of the side of the inserting portion 11 in left and right direction, the inclined plane 112 can also be placed at both sides of the inserting portion 11 in left and right direction.

The periodontal pocket depth measuring device of the present invention is used to measure the periodontal pocket depth.

What is claimed is:

1. A periodontal pocket depth measuring device comprising:
a main body;
a probe tabular in shape extending from a side of the main body and the probe is mounted within the main body, the probe comprises a concave structure which is located at the front end of the protruding direction and in the middle of the tabular width direction;
a lip extending from the side of the main body along the same protruding direction as the probe, wherein the lip can freely move in parallel to the protruding direction, the lip is slidably mounted into the main body and is located close to the probe; and
a measuring portion measuring the depth by measuring the movement in a direction opposite to the lip protruding direction.

2. The periodontal pocket depth measuring device of claim 1, wherein the concave structure is semicircular in shape.

3. The periodontal pocket depth measuring device of claim 1, wherein the probe comprises: a holding portion mounted within the main body, an inserting portion which is located at the front end of the protruding direction and can be inserted into the periodontal pocket, and a concave area which is located in between the inserting portion and the holding portion and concaves towards the inside on the side of the tabular width direction.

4. The periodontal pocket depth measuring device of claim 1, wherein the lip comprises a tabular portion that intersects with the protruding direction of the lip at around the front end of the probe;
the tabular portion comprises an insertion through-hole which allows the probe to insert through, and the side of the tabular width protrudes outside towards the direction of the tabular width into a convex shape.

5. The periodontal pocket depth measuring device of claim 1, wherein the probe is located at a front end of the protruding direction with a predetermined angle with respect to the tabular width direction and extends along the tabular width direction.

6. The periodontal pocket depth measuring device of claim 1, wherein the probe comprises an inclined plane that its thickness gets narrower and tilts towards the front end of the protruding direction.

7. The periodontal pocket depth measuring device of claim 1, wherein the probe and the lip are made of paper.
